(19) United States
(12) Patent Application Publication
(10) Pub. No.: US 2008/0302985 A1
(43) Pub. Date: Dec. 11, 2008

(54) Handle with Torque Limiter and Fluid Controller Having the Handle

(76) Inventors: Kunihiko Daido, Osaka (JP); Hisatoshi Akamoto, Osaka (JP)

Correspondence Address: Pearl Cohen Zedek Latzer, LLP, 1500 Broadway, 12th Floor, New York, NY, 10036, US

(21) Appl. No.: 11/667,557

(22) PCT Filed: Sep. 27, 2005
(86) PCT No.: PCT/JP05/17784

§ 371 Date: Nov. 13, 2007

(30) Foreign Application Priority Data
Nov. 12, 2004 (JP) 2004-329541

(51) Int. Cl. F16K 31/60; F16K 31/50; F16K 7/16

(52) U.S. Cl. 251/81; 251/230

(57) ABSTRACT

To provide a handle with a torque limiter capable of performing the opening/closing operation of a flow passage with a specified tightening force, less causing wear and damage to a valve element even if repeatedly used, capable of stably controlling a flow rate over a long period, capable of securely performing the opening of the flow passage, and manufacturable at low cast and a fluid controller having the handle with the torque limiter. This handle with the torque limiter comprises a handle body (62) connected to an operating mechanism (5) vertically moving the valve element by a rotating operation and a cover body (61) fitted to the handle body. The handle body comprises a ratchet wheel (7), and the cover body comprises a ratchet claw (8) rotatable about a pivot shaft (81) and a spring (9) energizing a force to rotate the ratchet claw in a direction for engaging the ratchet claw with the outer peripheral teeth for the ratchet wheel. The spring receives a pressing force from the ratchet claw in a retracting direction only when the cover is rotated in one direction to retract so as to allow the rotation of the ratchet claw to an angle at which the engagement thereof with the teeth is released when the pressing force exceeds a prescribed value.

### BACKGROUND OF THE INVENTION

1. Field of the Invention

The present invention relates to a torque limiting handle and a fluid controller with the handle. The present invention particularly relates to a handle having a torque-limiting function for protecting a diaphragm from an excessive torque. The present invention also relates to a fluid controller with the handle to be opened and to be closed with a constant tightening force. This enables to protect valve membrane in the fluid controller from a deformation due to an excessive tightening in closing operation such that little damage or wearing of the valve membrane is caused. Therefore it is possible to use the fluid controller to stably control the flow rate over a long period.

2. Description of the Background Art

Diaphragm valves are generally used to control fluid flow in a chemical industry plant for handling corrosive fluid or high purity fluid.

As an example, FIG. 5 shows a diaphragm valve comprising a valve case (A) having a fluid channel (A-1), a diaphragm (B) making contact with and moving apart from the fluid channel (A-1), a pinching element (C) for fixating the periphery of the diaphragm (B), an operation mechanism (D) for controlling the diaphragm (B) such that diaphragm (B) makes contact with or moves apart from the surface of the fluid channel (A-1) and a handle (E) connected to the operation mechanism (D).

In this diaphragm valve, as shown in FIGS. 6 and 7, an operating bar (D-1) that forms a part of the operation mechanism is engagedly fixed to the inside of the handle (E). This operating bar (D-1) moves upwardly and downwardly while the handle (E) is rotated.

When the handle (E) is rotated, the operation mechanism (D) connected to the handle (E) moves upwardly and downwardly. This causes the diaphragm (B) to make contact with and move away from the abutting point (A-2) of the valve case (A) so that the fluid channel (A-1) is opened or closed.

Since the diaphragm (B) of the diaphragm valve (Z) described above is always in contact with fluid, diaphragm (B) is generally made of soft rubber material having an excellent corrosion resistance and flexibility. The fluid channel (A-1) is opened and closed with the soft rubber material. Thus, this fluid controller does not significantly interrupt the fluid flow. Also, soft-rubber diaphragm (B) provides high sealing performance to prevent the leakage of the fluid. Moreover the fluid controller with soft-rubber diaphragm (B) is free from corrosion. Thus, this fluid controller has been advantageously used for blocking chemical agents (e.g., acid).

In the conventional diaphragm valve (Z) of the configuration described above, however, diaphragm (B) tends to be damaged during shutting the fluid channel (A-1). This means that as the diaphragm valve (Z) is used repeatedly for a long time, the diaphragm (B) is seriously damaged. Therefore there is a problem that such a conventional diaphragm valve (Z) cannot stably control fluid flow over a long period.

Specifically, in the diaphragm valve (Z) described above, the fluid channel (A-1) is closed by rotating the handle (E) to move down the operation mechanism (D) and then to compress the diaphragm (B) to the predetermined abutting point (A-2). When the fluid channel (A-1) is closed in this way, the handle (E) often excessively compresses the diaphragm and applies an excessive load on the diaphragm. Accordingly, during repeated use for many years, the diaphragm (B) tends to damage and abrade. Therefore, this valve (Z) cannot stably control fluid flow over a long period.

Considering these problems, the applicant of this application has created the technique disclosed in Japanese Patent No. 3,358,147.

The technique disclosed in Japanese Patent No. 3,358,147 enables a diaphragm to open and close a fluid channel with a constant compressing force. The technique disclosed therein is excellent in that the valve hardly damages or abrades during repeated use and serves for stable flow control over a long period.

The valve disclosed therein, however, sometimes has a difficulty in opening the fluid channel since, in this valve, the lower end of a spherical transmitting member is engaged into a spherical concave portion using pushing force of an elastic element.

Specifically, in the configuration of the valve disclosed therein, the resisting force during a clockwise rotation of the handle is equivalent to the resisting force during an anticlockwise rotation of the handle. This leads to a problem that it is sometimes difficult or impossible to rotate the handle to open the fluid channel. Ideally, just in an operation to close the valve, the handle rotation should be controlled so that the diaphragm is not compressed too much (i.e. allowing the handle to rotate idly without affecting the operation mechanism).

Furthermore the valve comprises a lot of parts. Therefore it is difficult to mass-produce this valve, and also this valve becomes very expensive.

In the prior art, it is well known to apply the technique using a ratchet mechanism to open and close a valve (e.g., Japanese Utility Model Publication H5-53879 and Japanese Utility Model Publication S57-94773).

However the technique disclosed in Japanese Utility Model Publication H5-53879 is intended to mechanically carry out automatic opening and closing of the valve, without utilizing electricity or fluid pressure.

Japanese Utility Model Publication S57-94773 discloses a valve used for liquid distribution. The valve comprises multiple valve cases from which the liquid is delivered to desired locations such as agricultural fields and golf links. The liquid destination is selected by which valve case is connected to the inlet of the valve.

With the techniques disclosed in Japanese Utility Model Publication H5-53879 and Japanese Utility Model Publication S57-94773, it is not possible to prevent an excessive torque using a ratchet mechanism. Particularly, there is no way to protect a valve membrane of a fluid controller from a damage caused by excessive torque using a ratchet mechanism.

In order to solve the above-described problems of the prior arts, the present invention provides a fluid controller that uses a valve membrane (e.g. diaphragm) to open and close a fluid channel with a constant tightening force such that little abrasion or damage is caused to the valve membrane (e.g. diaphragm). Using the fluid controller, it is possible to stably control fluid flow over a long period and to securely open the fluid channel. Also, the fluid controller enables reduction of the manufacturing cost. The present invention also provides a torque limiting handle configured to rotate to vertically displace the operation mechanism of a fluid controller or the like while preventing an excessive torque.

### SUMMARY OF THE INVENTION

The present invention according to claim 1 relates to a torque limiting handle to be used in an apparatus having an operation mechanism (5) that is vertically moved by rotation of a handle (6) comprising: a handle body (62) connected to the operation mechanism and having a ratchet wheel (7); and a cover portion (61) surrounding the handle body and having a ratchet claw (8) and a spring (9) that provides a bias force to the ratchet claw so that the ratchet claw rotates to engage with teeth formed on outer peripheral surface of the ratchet wheel; wherein the ratchet claw is configured to apply a pressing force to the spring to be in a compressed position only when the cover portion is rotated in either direction and wherein the spring is compressible to allow the ratchet claw to rotate until the ratchet claw disengages from the teeth when the pressing force exceeds a predetermined level.

The present invention according to claim 2 relates to a fluid controller comprising: a valve case (2) having a channel extending therethrough; a valve membrane (3) configured to open or close the channel; an operation mechanism having a bottom end connected to the upper side of the valve membrane; and a handle configured to vertically displace the operation mechanism, the handle comprising: a handle body (62) connected to the operation mechanism and having a ratchet wheel (7); and a cover portion (61) surrounding the handle body and having a ratchet claw (8) and a spring (9) that provides a bias force to the ratchet claw so that the ratchet claw rotates to engage with teeth formed on outer peripheral surface of the ratchet wheel; wherein the ratchet claw is configured to apply a pressing force to the spring to be in a compressed position only when the cover portion is rotated in either direction and wherein the spring is compressible to allow the ratchet claw to rotate until the ratchet claw disengages from the teeth when the pressing force exceeds a predetermined level.

According the present invention defined in claim 1, only when the cover portion is rotated in one direction with an excessive torque by disengaging the teeth of the ratchet wheel from the ratchet claw, the cover portion rotates independently from handle body. Even if the handle is tightened with the excessive torque, the tightening force is not transmitted to the operation mechanism. Therefore the handle according to the present invention is widely applied to any apparatus that requires prevention of the excessive torque.

According to the present invention in claim 2, the cover portion rotates independently from the handle only when the handle is rotated to a channel closing direction with an excessive load. On the other hand, the rotary torque of the cover portion is securely transmitted to the handle when the cover portion is rotated in a channel opening direction. It is possible to always provide the valve membrane with a constant force for a channel opening/closing operation. This results in a reduction in abrasion and damage of the valve membrane over a repeated use and therefore a stable fluid control over a long period is achieved. Moreover, the fluid controller of the present invention includes a less number of components than a conventional fluid controller, which reduces the manufacturing cost of the fluid controller.

### DETAILED DESCRIPTION

The torque limiting handle according to the present invention may be used in an apparatus having an operation mechanism that is moved vertically by the rotation of the handle. The torque limiting handle is suitable to any apparatuses that require torque management (or that need to prevent production of an excessive torque). The application in a fluid controller is set forth herein as a typical application, though the application of the torque limiting handle is not particularly restricted to this.

FIG. 1 is a top view of the torque limiting handle according to the present invention. FIG. 1 omits an upper cover of the torque limiting handle. FIG. 2 is a longitudinal cross sectional view of a fluid controller with the handle (as shown in FIG. 1) according to the present invention.

As shown in FIG. 2, the fluid controller (1) according to the present invention includes a valve case (2) having a channel (21) formed therethrough; a valve membrane (3) configured to open and close the channel (21); a bonnet (4) configured to sandwich a periphery of valve body (3) with valve case (2); an mechanism (5) having a bottom end connected to an upper side of valve membrane (3); and a handle (6) configured to vertically move operation mechanism (5).

According to the embodiment shown in FIG. 2, the fluid controller (1) includes a diaphragm valve, which has a diaphragm as a valve membrane. In the following description, valve membrane (3) will be explained as diaphragm (3).

The present invention may be applied not only to a diaphragm valve but also to substantially all fluid controllers that may cause excessive tightening. For example, the present invention is preferably applied to a disc valve, a needle valve, a plug valve, a bellows valve, and the like.

“Valve membrane” as used herein refers to a diaphragm as well as to a valve membrane used in those other fluid controllers to open and close a channel.

Handle (6) includes a handle body (62) connected concentrically to the upper part of operation mechanism (5) and a cover portion (61) surrounding the handle body (62). An upper cover (63) is engaged in the upper side of cover portion (61).

Upper end of handle body (62) includes a number of teeth placed on its outer peripheral wall with a constant pitch and protruding therefrom. The respective teeth are configured to engage with a ratchet claw (described below). The teeth cooperatively constitute a ratchet wheel (7).

Cover portion (61) includes a ratchet claw (8) and a spring (9). Ratchet claw (8) is rotatable around a pivot shaft (81). Spring (9) is configured to provide a bias force to ratchet claw (8) to rotate in a direction (engaging direction) such that ratchet claw (8) engages or mates with the above-described teeth formed in the outer peripheral wall of ratchet wheel. The engaging direction corresponds to the counterclockwise direction in FIG. 1.

Excessive angular displacement of ratchet claw (8) is limited by the wall (10) in order to prevent ratchet claw (8) from completely disengaging from the teeth of ratchet wheel (7) while the ratchet claw (8) rotates in the engaging direction due to the bias force from spring (9).

Spring (9) is received in a cylindrical cavity defined in cover portion (61). When cover portion (61) is rotated in one direction (the clockwise direction in FIG. 1), ratchet claw (8) receives a reaction force from ratchet wheel (7), which does not rotate in spite of rotation of cover portion (61). From the ratchet claw (8), spring (9) receives a pressing force in a compression direction (see FIG. 3). The compression direction of spring (9) corresponds to a tangential direction of ratchet wheel (7).

When the pressing force exceeds a predetermined level and spring (9) is compressed, ratchet claw (8) rotate in one direction (the clockwise direction in FIG. 1) beyond the teeth of ratchet wheel (7) so as to disengage from the teeth (see FIG. 4). Cover portion (61) in this state does not transmit rotary torque to handle body (62) and cover portion (61) rotates independently from handle body (62).

When the pressing force is below the predetermined level and no or little compression of spring (9) is caused, ratchet claw (8) does not disengage from the teeth of ratchet wheel (7). Cover portion (61) in this state transmits rotary torque to handle body (62) such that cover portion (61) rotates together with handle body (62).

On the other hand, when cover portion (61) is rotated in the other direction (counterclockwise direction in FIG. 1), spring (9) receives no pressing force in the compression direction from ratchet claw (8). Therefore no compression of spring (9) is caused. Accordingly, ratchet claw (8) does not disengage from ratchet wheel (7). Cover portion (61) in this state transmits rotary torque to the handle body (62) such that cover portion (61) rotates together with handle body (62).

In the above-described operation, the rotary torque at which cover portion (61) starts to rotate independently from handle body (62) may be determined as any level by adjusting the restoring force of spring (9).

The adjustment of the restoring force of spring (9) may be performed by using another spring with a different spring constant or by increasing and decreasing the amount of compression of spring (9) sitting in the cavity of cover portion (61).

The embodiment shown employs the latter way.

Specifically, spring (9) is mounted between ratchet claw (8) and one side of an adjustment plate (11). Tip of a screw (12) is in contact with the rear side of adjustment plate (11). Screw (12) is threaded in a thread hole defined through cover portion (61). Screw (12) is rotated by a driver or a hexagonal wrench or the like inserted from outside of cover portion (61) through the thread hole.

With such a configuration, when screw (12) is rotated so as to displace along the thread hole, the displacement of screw (12) causes adjustment plate (11) to displace inside the cavity. The displacement of the adjustment plate (11) changes the spring length offset from the natural length. Thus it is easy to adjust the rotary torque at which cover portion (61) starts to rotate independently from handle body (62).

The operation of a fluid controller with a handle of the above-described configuration will be described below.

To close channel (21), cover portion (61) of handle (6) is rotated in a tightening direction (the clockwise direction).

If the rotary torque of cover portion (61) is below a certain value, no or little compression of spring (9) is caused and ratchet claw (8) does not disengage from the teeth of ratchet wheel (7).

Accordingly, rotary torque of cover portion (61) is transmitted to handle body (62) to rotate it together with cover portion (61). The rotation of handle body (62) allows operation mechanism (5) to move it downwardly such that diaphragm (3) contacts sealing area (22) of channel (21) so as to close channel (21).

Further rotation of handle (6) in the tightening direction while diaphragm (3) is in contact with sealing area (22) of channel (21) increases rotary torque of cover portion (61) beyond the certain value. Spring (9) is then compressed to allow ratchet claw (8) to rotate so as to disengage from the tooth of ratchet wheel (7).

After the disengagement, no rotary torque of cover portion (61) is transmitted to handle body (62) and cover portion (61) rotates independently from handle body (62). Thus diaphragm (3) is protected from an excessive pressure.

To open channel (21), cover portion (61) of handle (6) is rotated in a loosening direction (the counterclockwise direction).

In this case, spring (9) receives no pressing force from ratchet claw (8) in the compression direction. Therefore the engagement between ratchet claw (8) and ratchet wheel (7) is not released.

Accordingly, the rotary torque of cover portion (61) is transmitted to handle body (62) such that cover portion (61) rotates together with handle body (62). The rotation of handle body (62) allows operation mechanism (5) to move it upwardly such that diaphragm (3) moves apart from sealing area (22) so as to open channel (21).

In the fluid controller according to the present invention, the rotary torque at which cover portion (61) starts to rotate independently from handle body (62) is determined such that diaphragm (3) is not damaged.

Thus diaphragm (3) is protected from an excessive pressure and a resultant damage.

The present invention is suitable for a use in an apparatus that requires torque management, such as a fluid controller for controlling a fluid flow-rate in a chemical industrial plant

### BRIEF DESCRIPTION OF THE DRAWINGS

Hereinafter, preferred embodiments of the torque limiting handle and the fluid controller with the handle according to the present invention will be described with reference to the drawings.

FIG. 1 is a top view illustrating the torque limiting handle according to the present invention. The figure omits the upper cover of the handle.

FIG. 2 is a longitudinal cross sectional view of a fluid controller including the handle shown in FIG. 1.

FIG. 3 is a view illustrating the operation of the torque limiting handle according to the present invention.

FIG. 4 is a view illustrating the operation of the torque limiting handle according to the present invention.

FIG. 5 is a cross sectional view of one example of conventional diaphragm valves.

FIG. 6 is a top view of one example of handle of the diaphragm valve shown in FIG. 5.

FIG. 7 is a cross sectional view along line C-C′ of FIG. 6.

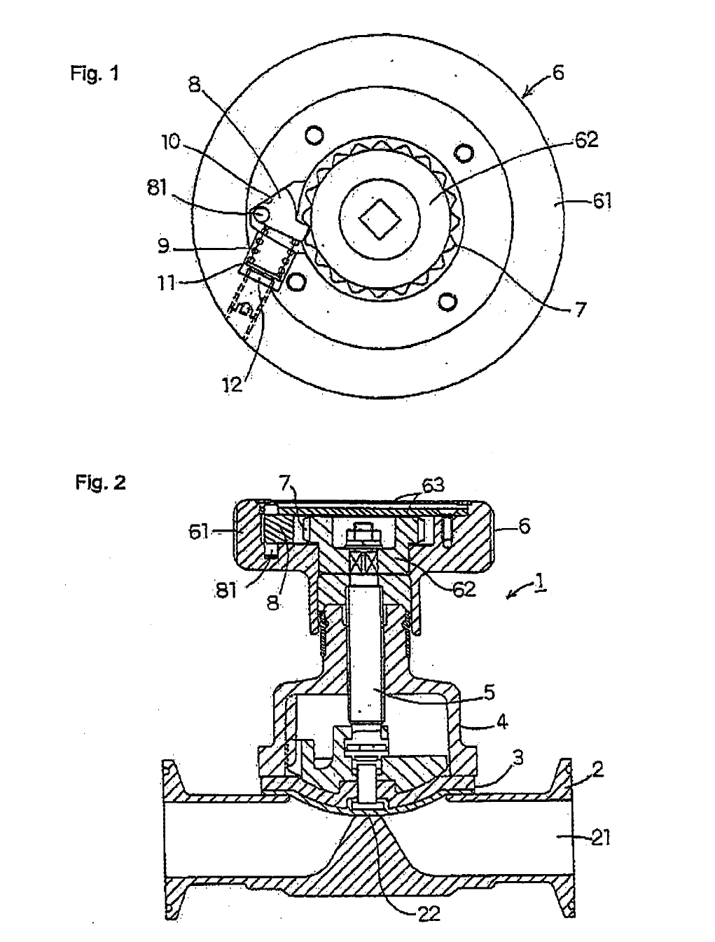

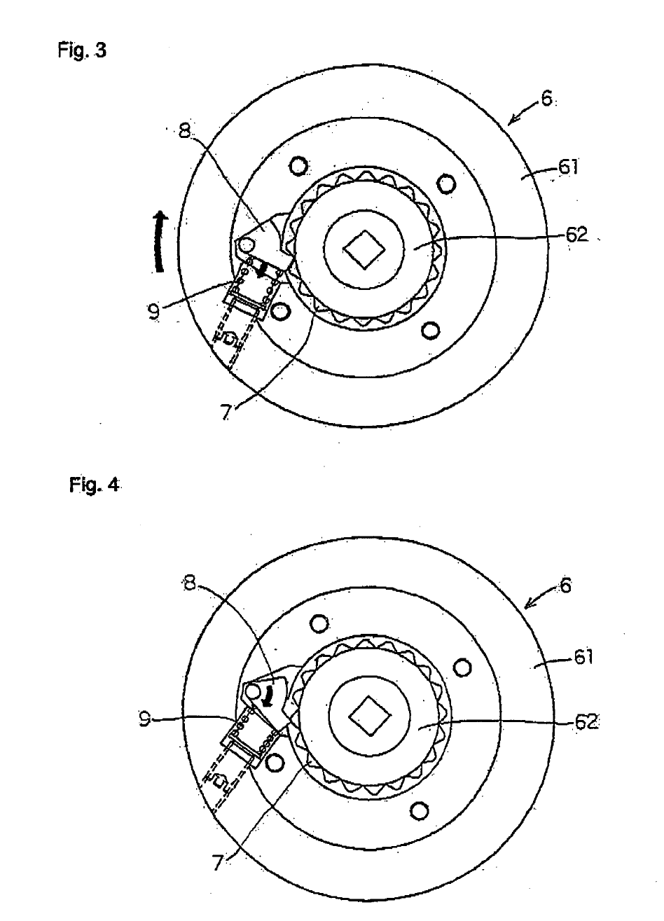

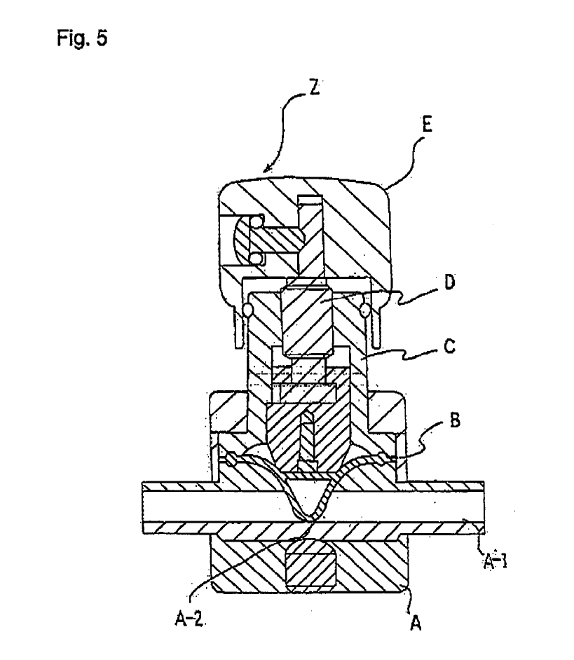

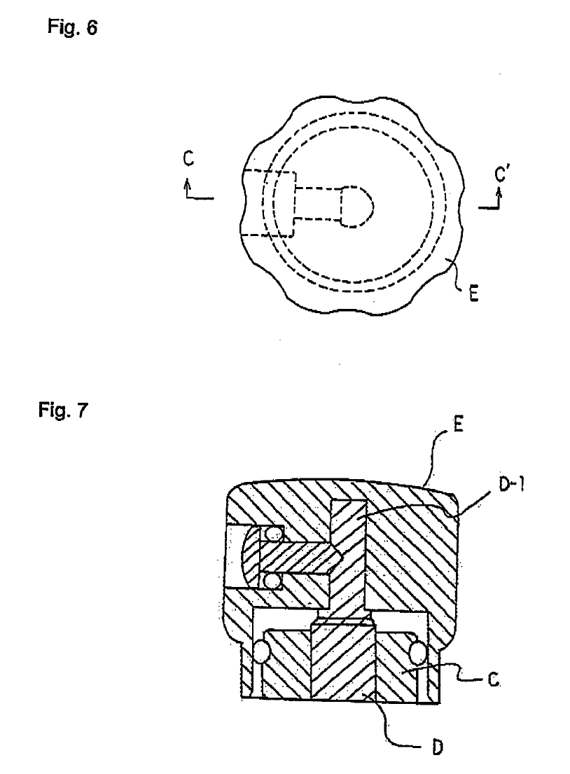

### EXPLANATION OF THE REFERENCE NUMERALS

1 Fluid controller
2 Valve case
21 Channel
3 Valve body (diaphragm)
4 Bonnet
5 Mechanism
6 Handle
61 Cover portion
62 Handle body
7 Ratchet wheel
8 Ratchet claw
81 Pivot Shaft
9 Spring

What is claimed is:

1. A torque limiting handle to be used in an apparatus having an operation mechanism (5) that is vertically moved by rotation of a handle (6) comprising:
a handle body (62) connected to the operation mechanism and having a ratchet wheel (7); and
a cover portion (61) surrounding the handle body and having a ratchet claw (8) and a spring (9) that provides a bias force to the ratchet claw so that the ratchet claw rotates to engage with teeth formed on outer peripheral surface of the ratchet wheel;
wherein the ratchet claw is configured to apply a pressing force to the spring to be in a compressed position only when the cover portion is rotated in either direction and wherein the spring is compressible to allow the ratchet claw to rotate until the ratchet claw disengages from the teeth when the pressing force exceeds a predetermined level.

2. A fluid controller comprising:
a valve case (2) having a channel extending therethrough;
a valve membrane (3) configured to open or close the channel;
an operation mechanism having a bottom end connected to the upper side of the valve membrane; and
a handle configured to vertically displace the operation mechanism, the handle comprising:
a handle body (62) connected to the operation mechanism and having a ratchet wheel (7); and
a cover portion (61) surrounding the handle body and having a ratchet claw (8) and a spring (9) that provides a bias force to the ratchet claw so that the ratchet claw rotates to engage with teeth formed on outer peripheral surface of the ratchet wheel;
wherein the ratchet claw is configured to apply a pressing force to the spring to be in a compressed position only when the cover portion is rotated in either direction and wherein the spring is compressible to allow the ratchet claw to rotate until the ratchet claw disengages from the teeth when the pressing force exceeds a predetermined level.
